(19) United States
(12) Patent Application Publication
(10) Pub. No.: US 2019/0324894 A1
(43) Pub. Date: Oct. 24, 2019

(54) METHOD, DEVICE AND COMPUTER READABLE STORAGE MEDIUM FOR VISUALIZATION OF TEST CASES

(71) Applicant: EMC IP Holding Company LLC, Hopkinton, MA (US)

(72) Inventors: Weiyang Liu, Shanghai (CN); Kang Teng, Shanghai (CN); Yuanyi Liu, Shanghai (CN); Zengjie Zhang, Shanghai (CN)

(21) Appl. No.: 16/114,798

(22) Filed: Aug. 28, 2018

(30) Foreign Application Priority Data
Apr. 20, 2018 (CN) 201810360946.7

(51) Int. Cl. G06F 11/36; G06F 17/30

(52) U.S. Cl. CPC G06F 11/3664; G06F 11/3684; G06F 17/30961; G06F 17/30994; G06F 11/3688

(57) ABSTRACT

Embodiments of the present disclosure provide a method, device and computer readable storage medium for visualization of test cases. In an embodiment, at least one test data file is obtained in which first test data and a first set of metadata for a manual test case and second test data and a second set of metadata for an automation test case are recorded. Visualized presentation of the manual test cases and the automation test cases is based on the first and second sets of metadata.

### FIELD

Embodiments of the present disclosure generally relate to computer technology, and more specifically, to a method, device and computer readable storage medium for visualization of test cases.

### BACKGROUND

During a process of software development, in order to ensure quality indicators such as accuracy, integrity and security of the software, software tests are generally required. A conventional approach for the software tests is to design dedicated test cases for different test requirements to verify the corresponding functions and performances of the software. At present, the design of test cases has become a core of software tests, while “how to create and maintain test cases” becomes a key of the whole process of software development.

A conventional approach of designing test cases is that the testers design or create manual test cases and automation test cases, respectively. The manual test cases may be in the form of an Excel spreadsheet or created using other case repositories including, for instance, a demand analysis model such as ROM (Rational Quality Manager), a case management system such as TestLink, and a test management tool such as a quality center (QC), and the like.

The testers may transfer a part of the manual test cases into automation test cases. For example, the testers may write the test data for the automation test cases into a part of the source code. The automation test data are generally organized into a particular data format, for instance, Extensible Markup Language (XML), Ain′t Markup Language (YAML), JSON (Java Script Object Notation), Comma-Separated Values (CSV) and so on, or implemented by other databases.

Such design and development of test cases generally require the testers to spend a lot of time and effort. For example, the testers first need to develop the manual test cases and then transfer the manual test cases into automation test cases. This transfer is not only time-consuming, but may also difficult to implement because manual test cases are generally, created from the perspective of the end user.

Moreover, the manual test cases and the automation test cases should be reviewed separately and subsequent update and maintenance of the functions should be performed separately. This is rather cumbersome and inefficient. In addition, it is difficult to synchronize the modifications and updates of the manual test cases and the automation test cases.

### SUMMARY

In general, embodiments of the present disclosure provide a method, device and computer readable storage medium for visualization of test cases.

In general, in one aspect, embodiments of the present disclosure provide a method for visualization of test cases. In the method, at least one test data file is obtained. In the test data file, first test data and a first set of metadata for manual test cases and second test data and a second set of metadata for automation test cases are recorded. Visualized presentation of the manual test cases and the automation test cases is based on the first and second sets of metadata.

In general, in one aspect, embodiments of the present disclosure provide a device for visualization of test cases. The device comprises a processor and a memory storing computer-executable instructions which, when executed by the processor, cause the device to perform a method, the method comprising: obtaining at least one test data file recording first test data and a first set of metadata for manual test cases and second test data and a second set of metadata for automation test cases; and generating a visualized presentation of the manual test cases and the automation test cases based on the first and second sets of metadata.

In general, in one aspect, embodiments of the present disclosure provide a computer readable storage medium having computer executable instructions stored thereon which, when executed by a processor, cause the processor to perform a method, the method comprising: obtaining at least one test data file recording first test data and a first set of metadata for manual test cases and second test data and a second set of metadata for automation test cases; and generating a visualized presentation of the manual test cases and the automation test cases based on the first and second sets of metadat.

It is to be understood that the content described in the Summary is not intended to identify key features or essential features of the claimed subject matter, nor is it intended to be used to limit the scope of the claimed subject matter. Other features of the present disclosure are disclosed in the following depiction.

### BRIEF DESCRIPTION OF THE DRAWINGS

Through the following detailed description with reference to the accompanying drawings, the above and other features, advantages and aspects of embodiments of the present disclosure will become more apparent. In the drawings, the same or similar reference symbols refer to the same or similar elements, in which:

FIG. 1 illustrates a conventional process of design and review of test cases;

FIG. 2 illustrates a visualization process of test cases in accordance with some embodiments of the present disclosure;

FIG. 3 illustrates an example structure of a mind map in accordance with some embodiments of the present disclosure;

FIG. 4 illustrates a visualization process of test cases in accordance with some embodiments of the present disclosure;

FIG. 5 illustrates test cases in the form of a mind map in accordance with some embodiments of the present disclosure;

FIG. 6 is a flowchart illustrating a method in accordance with some embodiments of the present disclosure; and

FIG. 7 is a block diagram illustrating a device suitable for implementing embodiments of the present disclosure.

### DETAILED DESCRIPTION OF EMBODIMENTS

Embodiments of the present disclosure will be described in the following in more details with reference to the drawings. Although some embodiments of the present disclosure are displayed in the drawings, it is to be understood that the present disclosure may be implemented in various manners, not limited to the embodiments illustrated herein. On the contrary, these embodiments are provided to make the present disclosure more thorough and complete. It is to be understood that the drawings of the present disclosure and embodiments thereof are only for the purpose of illustration, without the limitation to the scope of protection of the present disclosure.

As used herein, the term “includes” and its variants are to be read as open-ended terms that mean “includes, but is not limited to”. The term “based on” is to be read as “based at least in part on”. The term “one embodiment” is to be read as “at least one embodiment”; the term “another embodiment” is to be read as “at least one another embodiment”. The following text may also contain relevant definitions of other terms.

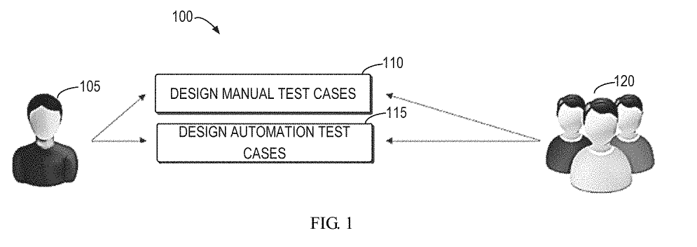

FIG. 1 illustrates an example process 100 of a conventional approach of designing and reviewing test cases. As shown in FIG. 1, manual test cases are first designed (block 110) by a tester 105. The manual test cases may be created using an Excel spreadsheet or other case repositories. Then, automation test cases are designed (block 115) by the tester 105, which may be transferred from at least a part of the manual test cases. Alternatively, the automation test cases may be created by the tester 105 dedicatedly based on test requirements.

The test data for the automation test cases are generally a part of the source code, which may be organized in a particular data format, such as XML, YAML, JSON and CSV. The following is an example of test data in YAML format.

add_one_ldap_binding2:

- metadata:

id: 7000
level: smoke
author: ‘YuanyiLiu’
description: ‘app api’

parameter_list:

| | |
|---|---|
| - | parameters: |

app: ‘zinc’
directory:

<<: *ad_api

validation_list:

| | |
|---|---|
| - | validations: |

code: 201

An automation test is generally data-driven, which makes it possible to use a single automation test case to execute multiple sets of test data. The following is a segment of example code used during an automation test process:

def login testcase

testcase[:parameter_list].zip(testcase[:validation_list]).each

do |parameter, validation|

account = parameter[‘account’]
password = parameter[‘password’]
display_name = validation[‘display_name’]
home_page = admin_login_page.login(account, password)
assert(home_page.logged_in?(display_name), “Display name of #{account} is
not correct.”)

end

end

The above codes may be executed iteratively using a plurality of test data so as to perform the same test process iteratively.

As described above, this approach of separately designing the manual and automation test cases generally requires the testers to spend a lot of time and effort. In addition, when the manual test cases and automation test cases are created, the testers may need to create API automation for a service layer or an application programming interface (API) call, and thus, they cannot learn the two creation phrases, comprehensively.

After the test cases are created, as shown in FIG. 1, the manual test cases and the automation test cases are respectively reviewed, maintained, updated and managed by an engineering team 120 consisting of testers, reviewers, and managers. As described above, this process is rather cumbersome and inefficient. Moreover, for the manual test cases in the form of a conventional Excel spreadsheet or created using other case repositories, due to poor readability, the reviewing and subsequent maintenance, update and management is not easy to implement.

Embodiments of the present disclosure provide an approach for visualization of test cases. In this approach, the test data and metadata for manual test cases and automation test cases are recorded in one or more test data files. With such test data files, visualized presentation of the test cases is enabled. In this way, the efficiency of the process of review, maintenance, update, management and the like is significantly improved for the test cases.

The visualization of test cases allows a friendly viewing interface to facilitate the review, maintenance, update and management. Moreover, only the test data files need to be created, maintained, updated and managed, thereby reducing the workload of the engineering team, significantly. Therefore, the efficiency of the whole life cycle of test cases including designing, creating and reviewing may be improved significantly.

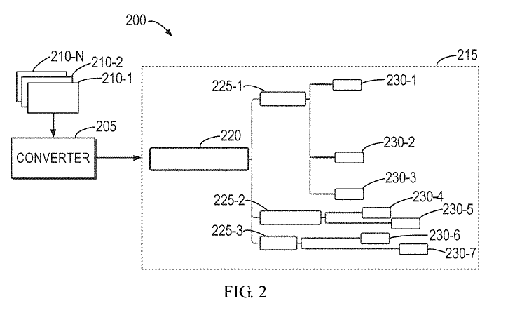

FIG. 2 shows an example visualization process 200 of test cases in accordance with some embodiments of the present disclosure. In this example, the process 200 is implemented by a converter 205, which may be implemented by hardware, software or a combination thereof. As an example, the converter 205 may be implemented by computer program code stored in a memory and executable by the processor.

The converter 205 obtains test data files 210-1, 210-2 . . . 210-N, which are collectively referred to as test data files 210. The test data files 210 record test data (referred to as “first test data”) and a set of metadata (referred to as “a first set of metadata”) for manual test cases, and test data (referred to as “second test data”) and a set of metadata (referred to as “second set of metadata”) for automation test cases.

The first and second sets of metadata may include any suitable information related to the corresponding test cases. For example, this information may include, but is not limited to, a case name, a case identifier (ID), a case identifier of a case author, a case type indicating whether the case is manual or automatic, a case level indicating a level of the test process that the case belongs to, case function description, and so on.

The test data files 210 may record the test data and metadata related to any suitable number and type of test cases. In some embodiments, one test data file 210 may record the test data and metadata for both the manual and automation test cases.

In some other embodiments, one test data file 210 may only record the test data and metadata of only one type of test case. For example, the test data files 210 may include one or more manual test data files, which record the first data and first metadata for the manual test cases, and one or more automation test data files which record the second data and the second metadata for the automation test cases.

The manual test data files may be designed or created by the tester 105 manually, for example, as shown in FIG. 1, while the automation test data files may be designed or created by the tester 105, for example, based on at least a part of the test data in the manual test data files, or based on the changes or update of the function or the test requirement.

Both the manual and automation test data files can be in any suitable format. In some embodiments, in order to further improve the automation efficiency of test cases, the manual and automation test data files can be in the same file format. For example, the manual and automation test data files can both be YAML file.

After obtaining the test data files 210, the converter 205 may implement visualized presentation 215 of the manual test cases and the automation test cases based on the first set of metadata for manual test cases and the second set of metadata for automation test cases recorded in the test data files 210. The visualized presentation 215 may be implemented in any suitable form. In some embodiments, the levels of the manual test cases and automation test cases during the test process may be determined based on the first set of metadata and the second set of metadata, and then the levels of the manual test cases and automation test cases may be presented visually.

The test cases may be presented visually in any suitable form of organizational structure. In the example as shown in FIG. 2, a tree structure is used to visually present the levels of the manual and automation test cases during the test process. The illustrated tree structure has three layers. The root node 220 represents the first level of the test process, and the first-level sub-nodes 225-1, 225-2 and 225-3 (collectively referred to as “first-level sub-nodes 225”) represent the second level of the test process. The leaf nodes 230-1, 230-2 . . . 230-7 (collectively referred to as “leaf nodes 230”) represent the specific test cases, including at least one type of the manual test case and the automation test case.

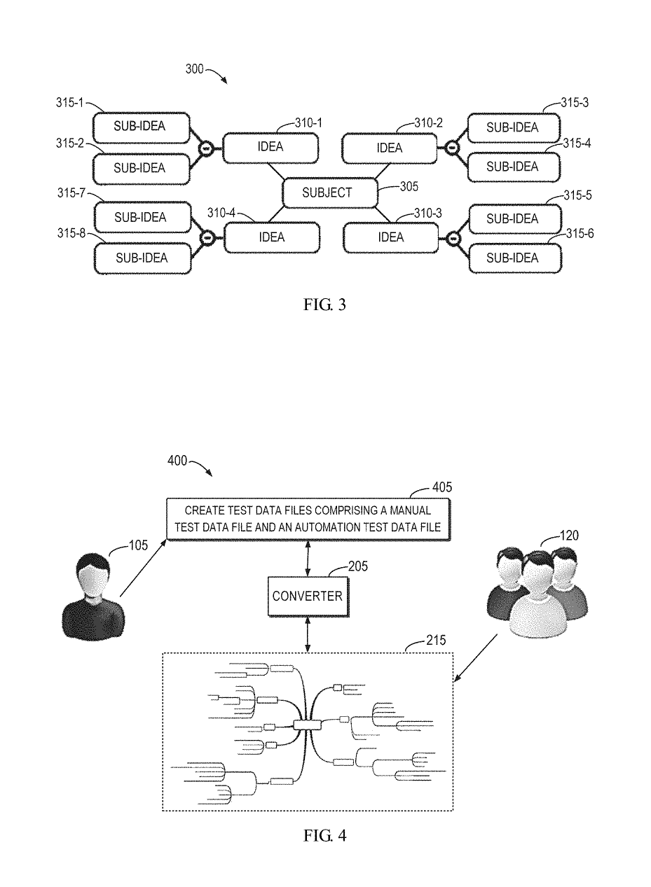

In some embodiments, a mind map may be used to present the test cases visually. The mind map is an efficient form of note-taking and generally has an organizational structure. FIG. 3 illustrates an example structure 300 in the form of a mind map. As shown in FIG. 3, in the structure 300, four ideas 310-1 to 310-4 radiate from a subject 305 located in the center, and eight sub-ideas 315-1 to 315-8 further radiate from the four ideas 310-1 to 310-4.

With this mind map, the manual test cases in the form of a monotonous Excel can be transformed into a highly organized and highly visible chart. Thus, the use of a mind map to demonstrate the test cases facilities the quick obtaining of test points by the engineering team including testers, reviewers or managers from the visualized structure and assists the engineering team in analysis and review.

FIG. 4 illustrates an example visualization process 400 of test cases in accordance with some other embodiments of the present disclosure. During the process 400, the test data and metadata for both the manual and automation test cases are first put by the tester 105 into the test data files 210 (block 405). In this example, the test data files 210 include manual and automation test data files for recording test data and metadata for the manual and automation test cases, respectively. Both the manual and automation test data files are YAML or XML files.

The converter 205 transfers the test data files 210 into the manual test cases and the automation test cases in order for them to be presented in a visualized manner. In this example, the converter 205 (which may include a mind map tool or another visualization conversion tool) transfers the test data files in the form of YAML or XML file format into the manual and automation test cases in the form of, for instance, a mind map. Moreover, as shown in FIG. 4, the converter 205 transfers the test cases in the form of a mind map reversely into a test data file using a mind map tool so as to implement test driving development (TDD).

Such test cases in the form of a mind map can show an overview of all the tested functional modules or functional points for view by the engineering team 120. When modification or update of the test cases is needed, the tester 105 only needs to modify or update the test data files 210. Then, the converter 205 may transfer the updated test data files again into the test cases in the form of a mind map using the visualization conversion tool.

A specific application scenario will be described below. In this example, the test data files 210 include the manual test data files and the automation test data files in the YAML file format. The code for the manual test data files are as follows:

fci_changejob_status:

| - | metadata: | |
|---|---|---|
| | | id: ‘4001’ |
| | | level: ‘skip’ |
| | | author: Yuanyi Liu’ |
| | | description: ‘stop fci job’ |
| | parameter_list: | |
| | - | parameters: |
| | validationlist: | |
| | - | validations: |
| - | metadata: | |
| | | id: ‘4002’ |
| | | level: ‘skip’ |
| | | author: ‘Yuanyi Liu’ |
| | | description: ‘fci job in blackout window’ |
| | parameter_list: | |
| | - | parameters: |
| | validation_list: | |
| | - | validations: |

fci_cleanup:

| - | metadata: | |
|---|---|---|
| | | id: ‘6001’ |
| | | level: ‘skip’ |
| | | author: ‘Yuanyi Liu’ |
| | | description: ‘validate fci task temp folder is cleanup when fci task completes' |
| | parameter_list: | |
| | - | parameters: |
| | validation_list: | |
| | - | validations: |
| - | metadata: | |
| | | id: ‘6002’ |
| | | level: ‘skip’ |
| | | author: ‘Yuanyi Liu’ |
| | | description: ‘validate fci job temp folder is cleanup when fci job completes' |
| | parameter_list: | |
| | - | parameters: |
| | validation list: | |
| | - | validations: |

In the above code, “fci_change_job_status” and “fci_cleanu” represent the tested functions. The metadata “id” represents case identifier, the metadata “author” represents author of the case, the metadata “description” represents function description of the case, and the metadata “level” represents the case type, where “skip” indicates that the case is manual.

The code for the automation test data files are as follows:

fci_documents:

| - | metadata: | |
|---|---|---|
| | | id: ‘2001’ |
| | | level: ‘smoke’ |
| | | author: ‘Yuanyi Liu’ |
| | | hierarchy: [‘server and client’, ‘single server’, ‘single client’, ‘windows'] |
| | | description: ‘fci single file’ |
| | parameter_list: | |
| | - | parameters: |

| query_string: | |
|---|---|
| - | <<: *non_fci_available item_query_string |
| | _source_id: *avamar_id |
| | _dp_entity_id: *avamar_client2_id |

| validationlist: | |
|---|---|
| - | validations: |

status: ‘success'

| - | metadata: | |
|---|---|---|
| | | id: ‘2002’ |
| | | level: ‘smoke’ |
| | | author: ‘Yuanyi Liu’ |
| | | hierarchy: [‘server and client’, ‘single server’, ‘single client’, ‘linux’] |
| | | description: ‘fci single file’ |
| | parameter_list: | |
| | - | parameters: |

| query_string: | |
|---|---|
| - | <<: *non_fci_available item query string |

_source_id: *avamar_id
_dp_entity_id: *avamar_clientl_id

| validation_list: | |
|---|---|
| - | validations: |

status: ‘success'

| - | metadata: | |
|---|---|---|
| | | id: ‘2003’ |
| | | level: ‘smoke’ |
| | | author: ‘Yuanyi Liu’ |
| | | hierarchy: [‘server and client’, ‘single server’, ‘single client’, ‘ndmp’, ‘vnx’] |
| | | description: ‘fci single file’ |
| | parameter_list: | |
| | - | parameters: |

| query_string: | |
|---|---|
| - | <<: *non_fci_available item query string |

_source_id: *avamar_id
_dp_entity_id: *avamar_client5_id

| validation_list: | |
|---|---|
| - | validations: |

status: ‘success'

In the above code, “fci_documents” represents the tested function. The metadata “id” represents the case identifier, the metadata “author” represents an author of the case, the metadata “description” represents function description of the case, and the metadata “level” represents the case type, where “smoke” indicates that the case is automatic.

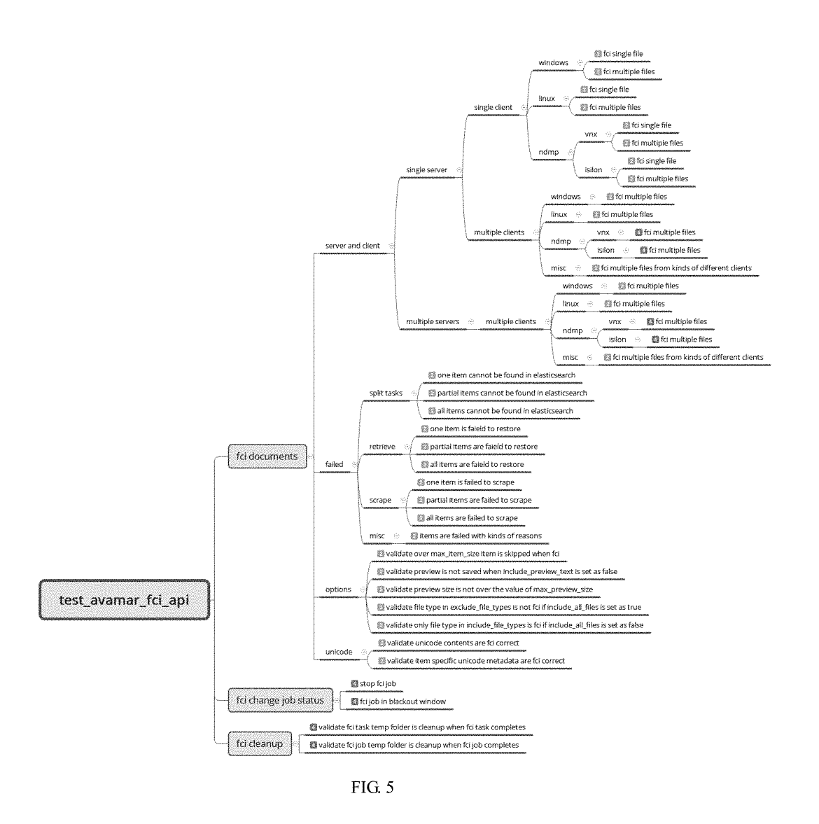

The test cases generated in the form of a mind map is shown in FIG. 5. In FIG. 5, “test_avamar_fci_api” represents a test module from which the first-level test sub-modules “fci documents,” “fci change job status” and “fci cleanup” are divided, and then the next-level test sub-models are divided from the first-level test sub-models, and so on. The number “2” represents a certain type of automation test cases, for instance, of a certain level of importance. It is also possible to use the numbers “1” and “3” to represent other types of automation test cases, for instance, of other levels of importance. The number “4” represents a manual test case. The numbers are followed by the function description of the cases.

This approach for visualized presentation of test cases simplifies significantly the workload of the engineering team consisting of testers, reviewers and managers and improves the satisfaction of the engineering team. For example, the testers only need to manage and maintain the test data files and do not need to create, maintain and update the manual test cases and the automation test cases separately. In this way, the workload of development and maintenance in each iterative period is reduced considerably. Moreover, the testers do not need to face the problem that the transfer from the manual test cases to the automation test cases is sometimes difficult to implement.

For the reviewers, visualized test cases are easier to view and review, thus reducing the review time significantly. Moreover, it is easier for the reviewers to propose suggestions for modifying the visualized test cases. For the managers, the test data files are easier to manage centrally. The managers also easily obtain statistic information on automation coverage, case coverage for each module, and the like.

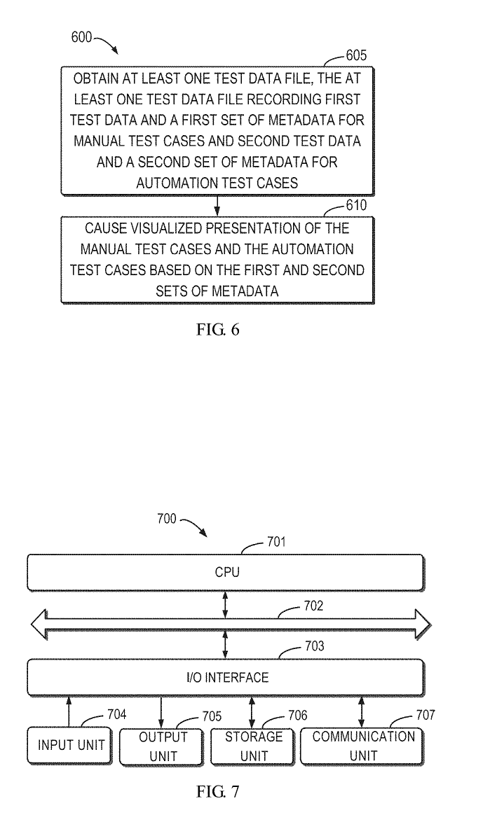

FIG. 6 is a flowchart illustrating an example method 600 in accordance with some embodiments of the present disclosure. The method 600 may be implemented at the converter 205 shown in FIG. 2.

As shown, at block 605, at least one test data file 210 is obtained. The test data file records the first test data and the first set of metadata for manual test cases and the second test data and the second set of metadata for automation test cases. At block 610, visualized presentation of the manual test cases and the automation test cases is based on the first and second sets of metadata.

In some embodiments, the at least one test data file may include a manual test data file recording the first test data and the first set of metadata and an automation test data file recording the second test data and the second set of metadata.

In some embodiments, the manual test data file and the automation test data file are in the same format.

In some embodiments, the levels of the manual test cases and the automation test cases during the test process may be determined based on the first set of metadata and the second set of metadata. Then, the visualized presentation of manual test cases and automation test cases is caused based on the determined levels.

In some embodiments, at least one set of the first and second sets of metadata includes at least one of the following: a case identifier, a case type, a case level and case function description.

In some embodiments, visualized presentation is in the form of a mind map.

In some embodiments, a change may be determined in at least one of the manual test cases and automation test cases presented visually, and the at least one test data file may be updated based on the determined changes.

It is to be understood that the operations performed by the converter 205 and the associated features described above with reference to FIGS. 2-5 are also applicable to the method 600 and have the same effects, and the specific details will not be repeated here.

FIG. 7 illustrates a schematic block diagram of a device 700 that may be used to implement embodiments of the present disclosure. As shown in FIG. 7, the device 700 includes a controller or a processor, or referred to as a central processing unit (CPU) 701 which can execute various appropriate actions and processing based on the computer program instructions stored in a read-only memory (ROM) and/or the computer program instructions loaded into a random access memory (RAM). ROM and/or RAM may store all kinds of programs and data required by operating the storage device 700. CPU 701, ROM and RAM are connected to each other via a bus 702. Particularly, the device 700 may further include one or more dedicated processing unit (not shown) which can be connected to the bus 702.

The input/output (I/O) interface 703 is also connected to the bus 702. A plurality of components in the device 700 are connected to the I/O interface 703, comprising: an input unit 704, such as keyboard, mouse and the like; an output unit 705, such as various types of displays, loudspeakers and the like; a storage unit 706, such as magnetic disk, optical disk and the like; and a communication unit 707, such as network card, modem, wireless communication transceiver and the like. The communication unit 707 allows the device 700 to exchange information/data with other devices through computer networks such as Internet and/or various telecommunication networks. In particular, in embodiments of the present disclosure, the communication unit 709 supports communication with the client or other devices.

In some embodiments, CPU 701 may be configured to perform various processes or processing described above, such as method 600. For example, in some embodiments, the method 600 can be implemented as computer software programs, which are tangibly included in a machine-readable medium, such as storage unit 706. In some embodiments, the computer program can be partially or completely loaded and/or installed to the device 700 via ROM and/or the communication unit 707. When the computer program is loaded to RAM and executed by CPU 701, one or more steps of the above described method 600 are implemented. Alternatively, in other embodiments, CPU 701 may also be configured to implement the above process/method in any other suitable manners.

Particularly, according to embodiments of the present disclosure, the process described above with reference to FIGS. 2-6 may be implemented as a computer program product which may be tangibly stored on a non-transient computer readable storage medium and includes computer-executable instructions, the instructions, when executed, causing the device to implement various aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The aspects of the present disclosure are described herein with reference to block diagrams and/or flowchart illustrations of devices, methods and computer program products according to embodiments of the present disclosure. It is to be understood that each block of the block diagrams and/or flowchart illustrations, and combinations of blocks in the block diagrams and/or flowchart illustrations, can be implemented by computer readable program instructions.

The descriptions of the various embodiments of the present disclosure have been presented for purposes of illustration, but are not intended to be limited to the embodiments disclosed. All the modifications and variations shall fall under the scope of protection of the present disclosure defined by the claims without departing from the essence of the present disclosure.

1. A method of visualization of test cases, comprising:
obtaining at least one test data file, the at least one test data file recording first test data and a first set of metadata for a manual test case and second test data and a second set of metadata for an automation test case;
generating a visualized presentation of the manual test cases and the automation test cases based on the first and second sets of metadata; and
displaying the visualized presentation.

2. The method according to claim 1, wherein the at least one test data file comprises a manual test data file and an automation test data file, the manual test data file recording the first test data and the first set of metadata, and the automation test data file recording the second test data and the second set of metadata.

3. The method according to claim 2, wherein the manual test data file and the automation test data file are in a same format.

4. The method according to claim 1, wherein generating the visualized presentation comprises:
determining, based on the first and second sets of metadata, levels of the manual test cases and the automation test cases during a test process; and
generating the visualized presentation of the manual test cases and the automation test cases based on the determined levels.

5. The method according to claim 1, wherein at least one of the first and second sets of metadata comprises at least one of a case identifier, a case type, a case level and a case function description.

6. The method according to claim 1, wherein the visualized presentation is in a form of a mind map.

7. The method according to claim 1, further comprising:
after the displaying:
determining a change in at least one of the manual test cases and the automation test cases based on the displayed visualized presentation; and
updating the at least one test data file based on the determined change.

8. A device for visualization of test cases, comprising:
a processor, and
a memory storing computer-executable instructions, the instructions, when executed by the processor, causing the device to perform a method, the method, comprising:
obtaining at least one test data file, the at least one test data file recording first test data and a first set of metadata for a manual test case and second test data and a second set of metadata for an automation test case;
generating a visualized presentation of the manual test cases and the automation test cases based on the first and second sets of metadata; and
displaying the visualized presentation.

9. The device according to claim 8, wherein the at least one test data file comprises a manual test data file and an automation test data file, the manual test data file recording the first test data and the first set of metadata, and the automation test data file recording the second test data and the second set of metadata.

10. The device according to claim 9, wherein the manual test data file and the automation test data file are in a same format.

11. The device according to claim 8, wherein generating the visualized presentation comprises:
determining, based on the first and second sets of metadata, levels of the manual test cases and the automation test cases during a test process; and
generating the visualized presentation of the manual test cases and the automation test cases based on the determined levels.

12. The device according to claim 8, wherein at least one set of the first and second sets of metadata comprises at least one of a case identifier, a case type, a case level and a case function description.

13. The device according to claim 8, wherein the visualized presentation is in a form of a mind map.

14. The device according to claim 8, wherein the method further comprising:
after the displaying:
determining a change in at least one of the manual test cases and the automation test cases in the visualization presentation; and
updating the at least one test data file based on the determined changes.

15. A non-transitory computer readable storage medium having computer executable instructions stored thereon, the computer executable instructions, when executed by a processor, causing the processor to perform a method, the method comprising:
obtaining at least one test data file, the at least one test data file recording first test data and a first set of metadata for a manual test case and second test data and a second set of metadata for an automation test case;
generating a visualized presentation of the manual test cases and the automation test cases based on the first and second sets of metadata; and
displaying the visualized presentation.

16. The non-transitory computer readable according to claim 15, wherein the at least one test data file comprises a manual test data file and an automation test data file, the manual test data file recording the first test data and the first set of metadata, and the automation test data file recording the second test data and the second set of metadata.

17. The non-transitory computer readable according to claim 16, wherein the manual test data file and the automation test data file are in a same format.

18. The non-transitory computer readable according to claim 15, wherein generating the visualized presentation comprises:
determining, based on the first and second sets of metadata, levels of the manual test cases and the automation test cases during a test process; and
generating the visualized presentation of the manual test cases and the automation test cases based on the determined levels.

19. The non-transitory computer readable according to claim 15, wherein at least one of the first and second sets of metadata comprises at least one of a case identifier, a case type, a case level and a case function description.

20. The non-transitory computer readable according to claim 15, wherein the visualized presentation is in a form of a mind map.
